(19) United States
(12) Patent Application Publication
(10) Pub. No.: US 2006/0132768 A1
(43) Pub. Date: Jun. 22, 2006

(54) Optical spectrometer

(75) Inventors: Charles Chuang, Taipei Hsien (TW); Chia-Jung Chang, Taipei Hsien (TW)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Chroma Ate Inc.

(21) Appl. No.: 11/019,821

(22) Filed: Dec. 22, 2004

(51) Int. Cl. G01J 3/28

(52) U.S. Cl. 356/328

(57) ABSTRACT

An optical spectrometer includes an input module, an optical sensing device, a light splitter, and a processing device. The input module includes an orifice unit through which an incident light beam passes. The optical sensing device includes a two-dimensional array of sensing cells arranged into a plurality of rows and columns. The light splitter splits the incident light beam from the input module into at least one wavelength component of a light band, and projects the wavelength component to the optical sensing device. The optical sensing device is disposed such that the wavelength component projected thereon is inclined at a predetermined angle relative to a columnar direction of the sensing cells. The processing device is coupled to the optical sensing device for processing electrical signals generated by the sensing cells.

### BACKGROUND OF THE INVENTION

1. Field of the Invention

The invention relates to an optical spectrometer, more particularly to an optical spectrometer that utilizes a two-dimensional array of sensing cells, to a method for calibrating an optical spectrometer, and to a method for optical spectroscopy.

2. Description of the Related Art

In general, an optical spectrometer provides an indication of wavelength content in an optical input. Referring to FIG. 1, a conventional optical spectrometer is shown to include an optical fiber 91 for transmitting a test light beam 90 through an orifice 92, a linear detector array 95, and an optical grating 93 disposed between the orifice 92 and the linear detector array 95. The optical grating 93 receives the test light beam 90 through the orifice 92, splits the test light beam 90 into its constituent wavelength components, and projects the wavelength components 94 to the linear detector array 95 for detection by linear sensing elements 950 of the latter, as best shown in FIG. 2. By analyzing electrical signals generated by the sensing cells 950 when the wavelength components are projected to the linear detector array 95, the constituent wavelength components of the test light beam 90 can be determined accordingly.

It is noted that the resolution of the optical spectrometer depends primarily on that of the linear detector array 95. If a high-resolution optical spectrometer is to be fabricated, a high-resolution linear detector array is mandated, thereby resulting in high manufacturing expenses. In addition, high precision in the mounting of the various optical components of the optical spectrometer is necessary to maintain an optimum output of the optical spectrometer.

In U.S. Pat. No. 6,785,002, there is disclosed an optical spectrometer that uses a tapered Fabry-Perot type variable optical filter in conjunction with a linear optical detector array. The stability of the variable optical filter allows a high-resolution spectrometer output, even when a low-resolution detector array is in use. Signal-processing techniques may be employed to enhance the resolution of the optical spectrometer beyond the measured response.

However, in view of the inclusion of the Fabry-Perot type variable optical filter, the manufacturing cost of the optical spectrometer is not considerably reduced. Moreover, high precision in the mounting of the various optical components of the optical spectrometer is still a must to maintain an optimum output of the optical spectrometer.

### SUMMARY OF THE INVENTION

Therefore, the object of the present invention is to provide an optical spectrometer that can overcome the aforesaid drawbacks of the prior art.

According to one aspect of the present invention, there is provided an optical spectrometer that comprises an input module, an optical sensing device, a light splitter, and a processing device.

The input module includes an orifice unit through which an incident light beam passes. The orifice unit has a width in a first direction and a length in a second direction far greater than the width.

The optical sensing device includes a two-dimensional array of sensing cells arranged into a plurality of rows and columns. Each of the sensing cells is capable of generating an electrical signal corresponding to light sensed thereby.

The light splitter is disposed between the input module and the optical sensing device, receives the incident light beam from the input module, splits the incident light beam into at least one wavelength component of a light band, and projects said at least one wavelength component to the optical sensing device.

The optical sensing device is disposed relative to the input module and the light splitter such that said at least one wavelength component projected thereon is inclined at a predetermined angle relative to a columnar direction of the sensing cells.

The processing device is coupled to the optical sensing device, and processes the electrical signals generated by the sensing cells so as to determine said at least one wavelength component of the incident light beam.

According to another aspect of the present invention, there is provided a method for calibrating an optical spectrometer that includes an input module, an optical sensing device, and a light splitter disposed between the input module and the optical sensing device. The input module includes an orifice through which an incident light beam passes. The orifice has a width in a first direction and a length in a second direction far greater than the width. The optical sensing device includes a two-dimensional array of sensing cells arranged into a plurality of rows and columns. Each of the sensing cells is capable of generating an electrical signal corresponding to light sensed thereby. The light splitter receives the incident light beam from the input module, splits the incident light beam into at least one wavelength component of a light band, and projects said at least one wavelength component to the optical sensing device.

The method comprises the steps of:

a) disposing the optical sensing device relative to the input module and the light splitter such that said at least one wavelength component to be projected thereon is inclined at an angle of inclination relative to a columnar direction of the sensing cells;

b) using a standard light beam as the incident light beam such that said at least one wavelength component projected to the optical sensing device is that of a standard light band;

c) processing the electrical signals generated by the sensing cells upon use of the standard light beam so as to determine a twist parameter associated with the angle of inclination; and

d) recording the twist parameter.

According to yet another aspect of the present invention, there is provided a method for optical spectroscopy to be implemented using an optical spectrometer that includes an input module, an optical sensing device, and a light splitter disposed between the input module and the optical sensing device. The input module includes an orifice through which an incident light beam passes. The orifice has a width in a first direction and a length in a second direction far greater than the width. The optical sensing device includes a two-dimensional array of sensing cells arranged into a plurality of rows and columns. Each of the sensing cells is capable of generating an electrical signal corresponding to light sensed thereby. The light splitter receives the incident light beam from the input module, splits the incident light beam into at least one wavelength component of a light band, and projects said at least one wavelength component to the optical sensing device. The optical sensing device is disposed relative to the input module and the light splitter such that said at least one wavelength component projected thereon is inclined at a predetermined angle relative to a columnar direction of the sensing cells.

The method comprises the steps of:

a) assigning an incrementing order of distinct wavelengths to coordinates of a lowermost row of the sensing cells in the two-dimensional array;

b) assigning individual wavelengths to coordinates of other ones of the sensing cells in the two-dimensional array based on the wavelength assigned to an aligned one of the sensing cells on the lowermost row, a unit distance from the lowermost row, a wavelength increment between two adjacent ones of the sensing cells on the lowermost row, and a twist parameter associated with the predetermined angle; and

c) determining the wavelength of said at least one wavelength component from an intersection point of said at least one wavelength component with a column boundary of the sensing cells in the two-dimensional array.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic perspective view of a conventional optical spectrometer;

FIG. 2 is a schematic diagram to illustrate the projection of wavelength components on a linear detector array of the conventional optical spectrometer of FIG. 1;

FIG. 3 is a schematic perspective view of the first preferred embodiment of an optical spectrometer according to the present invention;

FIG. 4 is a fragmentary schematic view to illustrate calculation of a twist parameter during a calibration procedure for the optical spectrometer of FIG. 3;

FIG. 5 is a flowchart to illustrate the calibration procedure for the optical spectrometer of the first preferred embodiment;

FIG. 6 is a flowchart to illustrate the method for optical spectroscopy using the optical spectrometer of the first preferred embodiment;

FIG. 7 is a fragmentary schematic view to illustrate how a wavelength component of an incident light beam is determined in the method of FIG. 6;

FIG. 8 is a schematic perspective view of the second preferred embodiment of an optical spectrometer according to the present invention;

FIG. 9 is a schematic side view of the third preferred embodiment of an optical spectrometer according to the present invention; and

FIG. 10 is a schematic perspective view of the fourth preferred embodiment of an optical spectrometer according to the present invention.

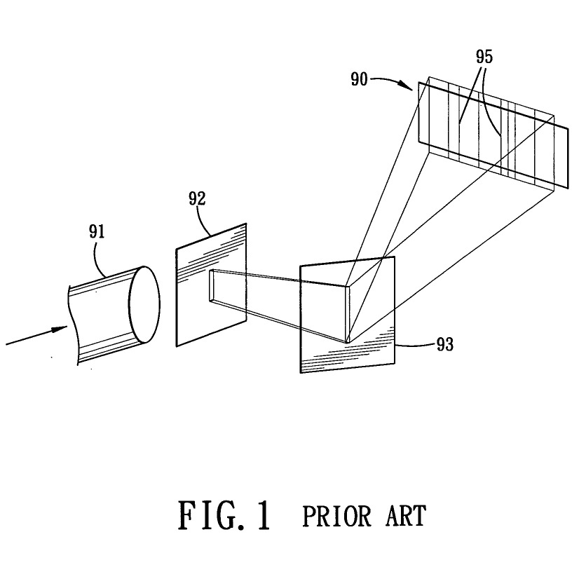

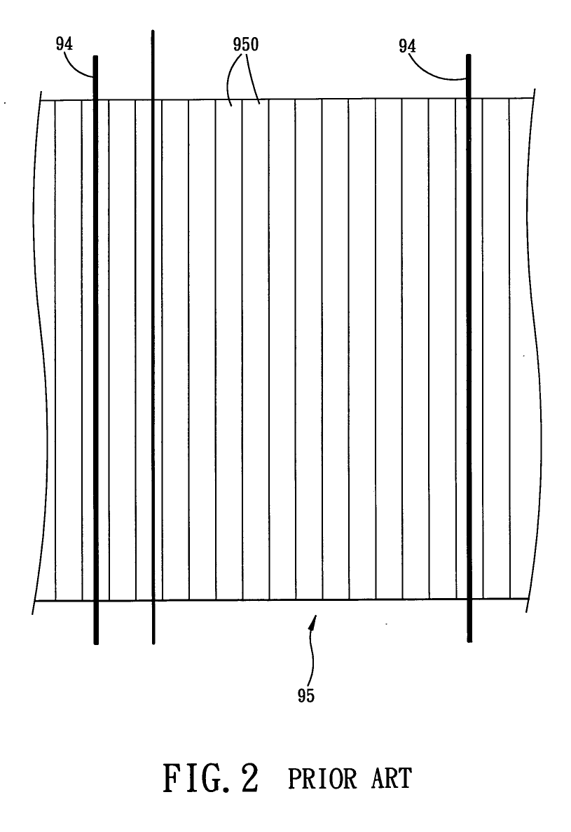

### DETAILED DESCRIPTION OF THE PREFERRED EMBODIMENTS

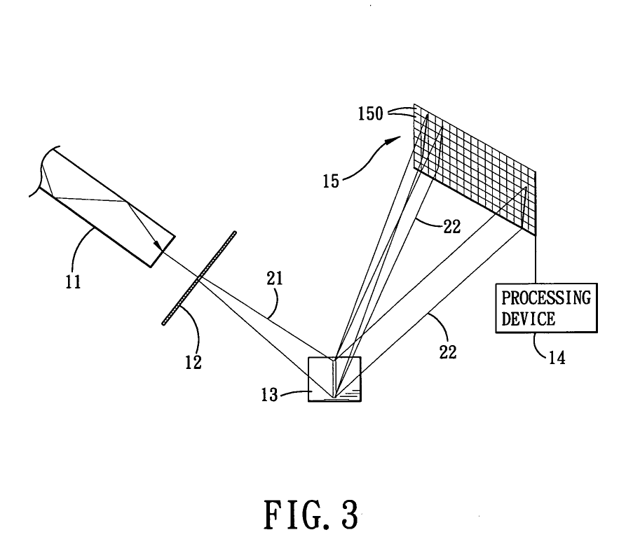

Referring to FIG. 3, the first preferred embodiment of an optical spectrometer according to the present invention is shown to comprise an input module, an optical sensing device 15, a light splitter 13 disposed between the input module and the optical sensing device 15, and a processing device 14 coupled to the optical sensing device 15.

In this embodiment, the input module includes an orifice 12 and an optical fiber 11 for transmitting an incident light beam 21 through the orifice 12. The orifice 12 has a width in a first direction and a length in a second direction far greater than the width.

Unlike the linear detector arrays used in conventional optical spectrometers, the optical sensing device 15 includes a two-dimensional array of sensing cells 150 arranged into a plurality of rows and columns. Each of the sensing cells 150 is capable of generating an electrical signal corresponding to light sensed thereby. For convenience of illustration, in the following description, an array-type CCD sensor, available from Sony Corporation as ICX074AL and having 692×504 (0.35 million) pixels, is used to exemplify the optical sensing device 15 of this embodiment.

The light splitter 13, such as an optical grating, receives the incident light beam 21 from the input module, and splits the incident light beam 21 into at least one wavelength component 22 of a light band. In FIG. 3, the incident light beam 21 is split into a plurality of wavelength components 22 that are projected to the optical sensing device 15.

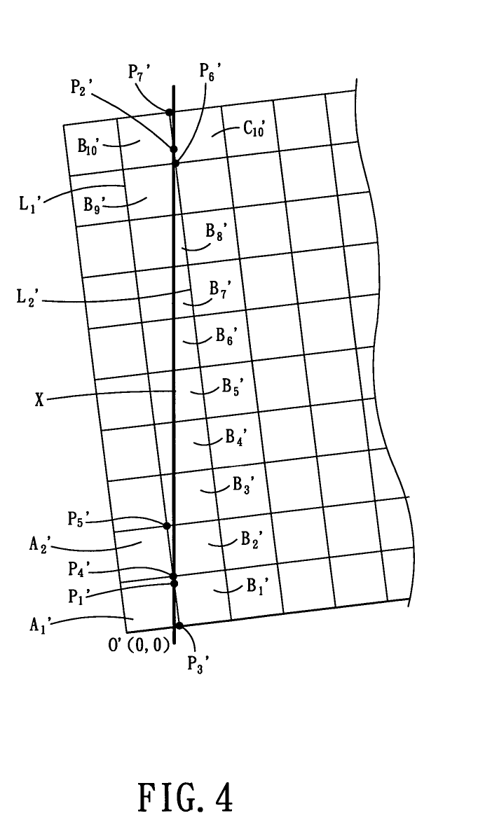

In this invention, the optical sensing device 15 is disposed relative to the input module and the light splitter 13 such that the wavelength components 22 projected thereon are inclined at a predetermined angle (determined during a calibration procedure to be described hereinafter) relative to a columnar direction of the sensing cells 150 in the two-dimensional array, as best shown in FIG. 4.

The processing device 14 is coupled to the optical sensing device 15, and processes the electrical signals generated by the sensing cells 150 so as to determine the wavelength components 22 of the incident light beam 21.

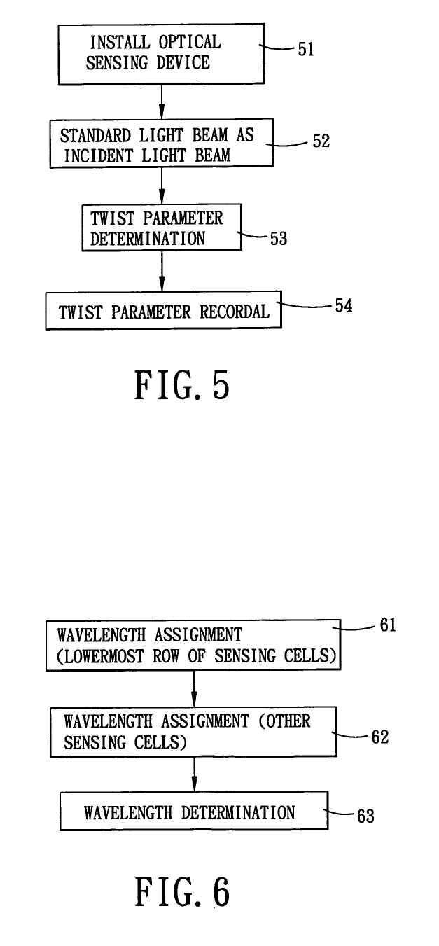

Before the optical spectrometer can be used to make actual measurements, there is a need for the optical spectrometer to undergo a calibration procedure. The method for calibrating the optical spectrometer of this embodiment will now be described with reference to FIGS. 4 and 5.

Initially, in step 51, the optical sensing device 15 is disposed relative to the input module and the light splitter 13 such that a wavelength component to be projected thereon is at an angle of inclination relative to a columnar direction of the sensing cells 150.

Then, in step 52, a standard light beam is used as the incident light beam 21 such that the wavelength component projected to the optical sensing device 15 is that of a standard light band.

Subsequently, in step 53, the electrical signals generated by the sensing cells 150 are processed by the processing device 14 upon use of the standard light beam so as to determine a twist parameter associated with the predetermined angle. In this step, a coordinate system is defined on the optical sensing device 15, with the lowermost left corner being assigned as the origin point O′ (0,0). The width and height of each sensing cell 150 is assumed to be 1 measurement unit.

In the example of FIG. 4, the wavelength component 22 of the standard light band is shown to intersect the column boundary (L₁′) of the first and second columns of the sensing cells 150 at a point (P₁′) that is adjacent to sensing cells (A₁′, B₁′), and further intersects the column boundary (L₂′) of the second and third columns of the sensing cells 150 at a point (P₂′) that is adjacent to sensing cells (B₁₀′/C₁₀′). The wavelength component 22 also crosses the sensing cells (B₂′, B₃′, . . . , B₉′).

The twist parameter can be calculated from the coordinates of the intersection points (P₁′, P₂′). As shown in FIG. 4, the coordinates of point (P₃′) are (1,0), those of point (P₄′) are (1,1), those of point (P₆′) are (2,9), and those of point (P₇′) are (2,10). Assuming that the ratio of the output of the sensing cell (A₁′) to that of the sensing cell (B₁′) is 9:1, and the ratio of the output of the sensing cell (B₁₀′) to that of the sensing cell (C₁₀′) is 3:7, the coordinates of the intersection point (P1′) are ( 1/10)×P₃′+( 9/10)×P₄′=(1, 0.9), where as the coordinates of the intersection point (P2′) are ( 7/10)×P₆′+( 3/10)×P₇′=(2, 9.3). Therefore, the twist parameter, that is, the slope of the wavelength component between the intersection points (P₁′, P₂′), can be calculated as (9.3−0.9)/(2−1)=8.4.

Calculation of the twist parameter is not limited to that described hereinabove. In practice, the twist parameter may be calculated from a weighted average of the electrical signals of the sensing cells 150 between the two column boundaries (L₁′, L₂′) of the sensing cells 150 in the two-dimensional array that were intersected by the wavelength component. In the example of FIG. 4, the outputs of the sensing cells (B₂′, B₃′, . . . , B₉′) are generally the same (i.e., magnitude=I₀). Assuming that the output of the sensing cell (B₁′) is ( 1/10) I₀, and that of the sensing cell (B₁₀′) is ( 3/10) I₀, the twist parameter can be calculated as (( 1/10) I₀+8I₀+( 3/10) I₀)/I₀=8.4, which is the slope of the wavelength component between the two intersected column boundaries (L₁′, L₂′).

Finally, in step 54, the twist parameter is recorded by the processing device 14.

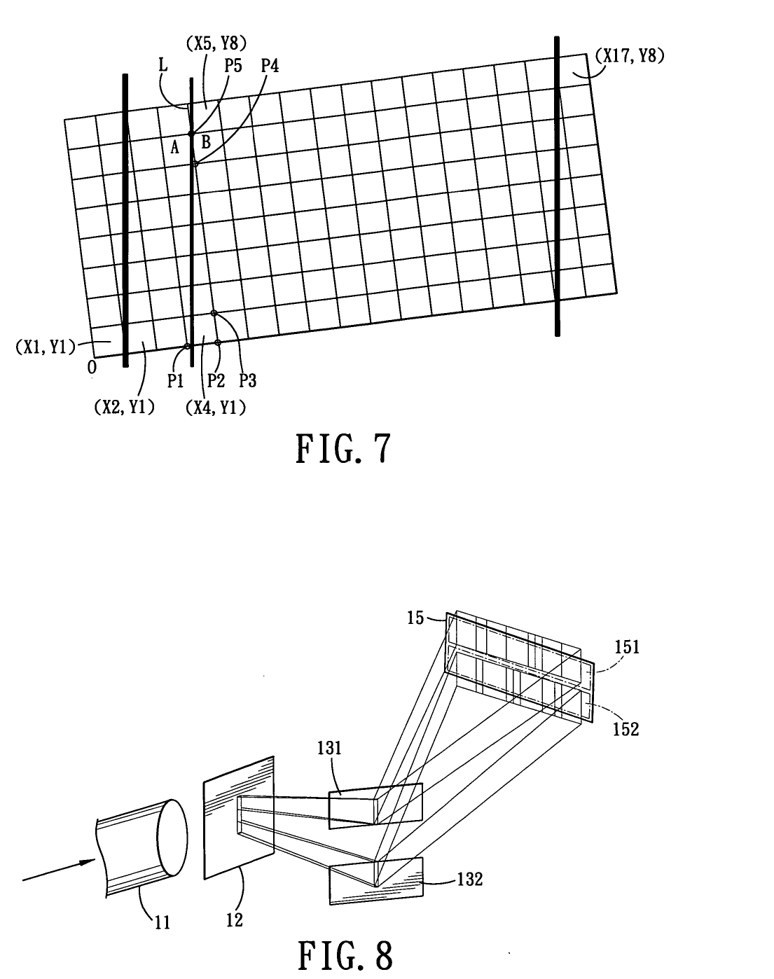

After recording the twist parameter, the optical spectrometer is ready for spectroscopy. The method for optical spectroscopy using the optical spectrometer of the first preferred embodiment will now be described in greater detail with reference to FIGS. 6 and 7. For convenience in calculations, it is assumed that the twist parameter obtained during the calibration procedure for the optical spectrometer is equal to 8.

In step 61, an incrementing order of distinct wavelengths is assigned to coordinates of a lowermost row of the sensing cells 150.

As shown in FIG. 7, it is assumed that the sensing cell (X1, Y1) at the origin point O (0,0) is assigned with a wavelength of 406 nm, and the coordinates of the other sensing cells (X2, Y1), (X3, Y1), (X4, Y1) . . . in the lowermost row are assigned with wavelengths in increments of 2 nm, i.e., 408 nm, 410 nm, 412 nm, . . .

Then, in step 62, individual wavelengths are assigned to coordinates of other ones of the sensing cells 150 based on the wavelength assigned to an aligned one of the sensing cells 150 on the lowermost row, a unit distance from the lowermost row, the wavelength increment (i.e., 2 nm) between two adjacent ones of the sensing cells 150 on the lowermost row, and the twist parameter (i.e., 8) associated with the predetermined angle.

As shown in FIG. 7, one wavelength component crosses the sensing cells (X4, Y1), (X4, Y2), (X4, Y3), . . . , (X5, Y7), (x5, Y8).

As set forth in the foregoing, P1 (3, 0) is associated with a wavelength 412 nm, and P2 (4, 0) is associated with a wavelength 414 nm. The wavelength assigned to P3 (4, 1) is thus equal to 414 nm (i.e., the wavelength assigned to P2)−0.25 nm (i.e., 2 nm/8)×1 (i.e., unit distance from P2)=413.75 nm. Using the same logic, the wavelength assigned to P4 (4, 6) is 412.5 nm, and that assigned to P5 (4, 7) is 412.25 nm.

In step 63, the processing device 14 determines the wavelength of the wavelength component from an intersection point of the wavelength component with a column boundary of the sensing cells 150 in the two-dimensional array.

In the example of FIG. 7, the wavelength component crosses a column boundary (L) between the points (P4, P5). Hence, the processing device 14 is able to determine that the wavelength of the wavelength component falls between 412.5 nm (P4) and 412.25 nm (P5). Therefore, through the method of optical spectroscopy of this invention, the measurement precision can be increased to the order of 10⁻¹ nm.

It is feasible to further increase the measurement precision of the optical spectrometer by taking into account the electrical signals generated by the sensing cells 150 adjacent to the intersection point. In particular, the processing device 14 determines a magnitude ratio of the electrical signals generated by two adjacent ones of the sensing cells (A, B) disposed respectively on two sides of the intersection point, and calculates the wavelength of the wavelength component with reference to the magnitude ratio and the wavelengths assigned to the coordinates of the two adjacent ones of the sensing cells 150.

Therefore, assuming that the magnitude ratio for the sensing cells A (X4, Y5) and B (X5,Y7) is 0.95:0.05, the wavelength of the wavelength component can be calculated by the processing device 14 to be: 0.95×412.25+0.05×412.5=412.262 nm. As a result, the measurement precision can be further increased to the order of 10⁻² nm.

In the first preferred embodiment, 692×8 sensing cells are sufficient to achieve high-resolution optical spectroscopy. However, since the optical sensing device 15 includes 692×504 sensing cells, it is feasible to group the sensing cells 150 into several independent sensing regions, with a sufficient spacer region between each adjacent pair of the sensing regions to minimize interference, for increasing utilization efficiency of the optical sensing device 15.

FIG. 8 illustrates the second preferred embodiment of this invention. In this embodiment, the sensing cells of the optical sensing device 15 are grouped into two sensing regions 151, 152. The light splitter includes two optical gratings 131, 132, each of which splits the incident light beam 21 through the orifice 12 into different sets of wavelength components that are projected to a corresponding one of the sensing regions 151, 152.

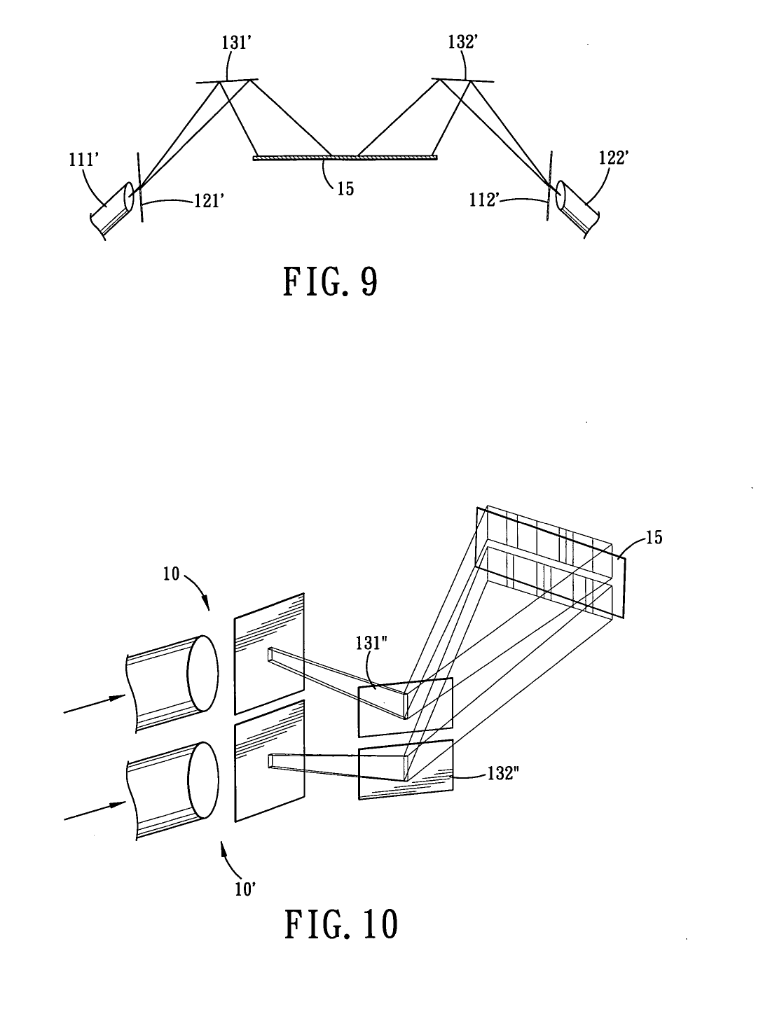

FIG. 9 illustrates the third preferred embodiment of this invention, which is a modification of the second preferred embodiment. In this embodiment, the input module includes two orifices 121′, 122′. Each of the optical gratings 131′, 132′ receives the incident light beam from a respective one of the orifices 121′, 122′. The input module further includes two optical fibers 111′, 112′, each of which transmits the incident light beam to a respective one of the orifices 121′, 122′.

FIG. 10 illustrates the fourth preferred embodiment of this invention. Unlike the second and third embodiments, the optical spectrometer of this embodiment includes an input module 10 and a calibration module 10′ similar to the input module 10 in construction. Each of the input and calibration modules 10, 10′ is associated with a respective optical grating 131″, 132″, and corresponds to a respective sensing region of the optical sensing device 15. The calibration module 10′ serves to provide a calibrating light beam such that calibration and actual measurement can be conducted simultaneously in the optical spectrometer of the fourth preferred embodiment.

Unlike the prior art described hereinabove, which require the use of high-resolution linear detector arrays, the optical spectrometer of this invention permits a high resolution output using less expensive, lower-resolution two-dimensional optical sensing devices without the requirement of high mounting precision.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. An optical spectrometer comprising:
an input module including an orifice unit through which an incident light beam passes, said orifice unit having a width in a first direction and a length in a second direction far greater than the width;
an optical sensing device including a two-dimensional array of sensing cells arranged into a plurality of rows and columns, each of said sensing cells being capable of generating an electrical signal corresponding to light sensed thereby;
a light splitter disposed between said input module and said optical sensing device, said light splitter receiving the incident light beam from said input module, splitting the incident light beam into at least one wavelength component of a light band, and projecting said at least one wavelength component to said optical sensing device;
said optical sensing device being disposed relative to said input module and said light splitter such that said at least one wavelength component projected thereon is inclined at a predetermined angle relative to a columnar direction of said sensing cells; and
a processing device coupled to said optical sensing device for processing the electrical signals generated by said sensing cells so as to determine said at least one wavelength component of the incident light beam.

2. The optical spectrometer as claimed in claim 1, wherein said input module includes an optical fiber for transmitting the incident light beam to said orifice unit.

3. The optical spectrometer as claimed in claim 1, wherein said light splitter includes an optical grating.

4. The optical spectrometer as claimed in claim 1, wherein said sensing cells are grouped into at least two sensing regions, said light splitter including at least two optical gratings, each of which splits the incident light beam received from said input module into said at least one wavelength component that is projected to a corresponding one of said sensing regions of said optical sensing device.

5. The optical spectrometer as claimed in claim 4, wherein said orifice unit includes at least two orifices, each of said optical gratings receiving the incident light beam from a respective one of said orifices.

6. The optical spectrometer as claimed in claim 5, wherein said input module includes at least two optical fibers, each of which transmits the incident light beam to a respective one of said orifices.

7. The optical spectrometer as claimed in claim 1, further comprising a calibration module for providing a calibrating light beam, said sensing cells being grouped into at least two sensing regions that correspond to said input module and said calibration module, respectively.

8. The optical spectrometer as claimed in claim 1, wherein coordinates of said sensing cells in a lowermost row of the two-dimensional array are assigned with an incrementing order of distinct wavelengths,
coordinates of other ones of said sensing cells in the two-dimensional array being assigned with individual wavelengths based on the wavelength assigned to an aligned one of said sensing cells on the lowermost row, a unit distance from the lowermost row, a wavelength increment between two adjacent ones of said sensing cells on the lowermost row, and a twist parameter associated with the predetermined angle,
said processing device determining the wavelength of said at least one wavelength component from an intersection point of said at least one wavelength component with a column boundary of said sensing cells in the two-dimensional array.

9. The optical spectrometer of claim 8, wherein said processing device determines the wavelength of said at least one wavelength component by determining a magnitude ratio of the electrical signals generated by two adjacent ones of said sensing cells disposed respectively on two sides of the intersection point, and by calculating the wavelength of said at least one wavelength component with reference to the magnitude ratio and the wavelengths assigned to the coordinates of said two adjacent ones of said sensing cells.

10. A method for calibrating an optical spectrometer that includes an input module, an optical sensing device, and a light splitter disposed between the input module and the optical sensing device,
the input module including an orifice through which an incident light beam passes, the orifice having a width in a first direction and a length in a second direction far greater than the width,
the optical sensing device including a two-dimensional array of sensing cells arranged into a plurality of rows and columns, each of the sensing cells being capable of generating an electrical signal corresponding to light sensed thereby,
the light splitter receiving the incident light beam from the input module, splitting the incident light beam into at least one wavelength component of a light band, and projecting said at least one wavelength component to the optical sensing device,
said method comprising the steps of:
a) disposing the optical sensing device relative to the input module and the light splitter such that said at least one wavelength component to be projected thereon is inclined at an angle of inclination relative to a columnar direction of the sensing cells;
b) using a standard light beam as the incident light beam such that said at least one wavelength component projected to the optical sensing device is that of a standard light band;
c) processing the electrical signals generated by the sensing cells upon use of the standard light beam so as to determine a twist parameter associated with the angle of inclination; and
d) recording the twist parameter.

11. The method of claim 10, wherein step c) includes:
c1) determining two intersection coordinates of said at least one wavelength component, each of the intersection coordinates being disposed at a corresponding one of a plurality of column boundaries of the sensing cells in the two-dimensional array; and
c2) calculating the twist parameter from the intersection coordinates determined in step c1).

12. The method of claim 10, wherein in step c), the twist parameter is equal to a weighted average of the electrical signals of the sensing cells between two column boundaries of the sensing cells in the two-dimensional array that were intersected by said at least one wavelength component.

13. A method for optical spectroscopy to be implemented using an optical spectrometer that includes an input module, an optical sensing device, and a light splitter disposed between the input module and the optical sensing device,
the input module including an orifice through which an incident light beam passes, the orifice having a width in a first direction and a length in a second direction far greater than the width,
the optical sensing device including a two-dimensional array of sensing cells arranged into a plurality of rows and columns, each of the sensing cells being capable of generating an electrical signal corresponding to light sensed thereby,
the light splitter receiving the incident light beam from the input module, splitting the incident light beam into at least one wavelength component of a light band, and projecting said at least one wavelength component to the optical sensing device,
the optical sensing device being disposed relative to the input module and the light splitter such that said at least one wavelength component projected thereon is inclined at a predetermined angle relative to a columnar direction of the sensing cells,
said method comprising the steps of:
a) assigning an incrementing order of distinct wavelengths to coordinates of a lowermost row of the sensing cells in the two-dimensional array;
b) assigning individual wavelengths to coordinates of other ones of the sensing cells in the two-dimensional array based on the wavelength assigned to an aligned one of the sensing cells on the lowermost row, a unit distance from the lowermost row, a wavelength increment between two adjacent ones of the sensing cells on the lowermost row, and a twist parameter associated with the predetermined angle; and
c) determining the wavelength of said at least one wavelength component from an intersection point of said at least one wavelength component with a column boundary of the sensing cells in the two-dimensional array.

14. The method of claim 13, wherein step c) includes:
c1) determining a magnitude ratio of the electrical signals generated by two adjacent ones of the sensing cells disposed respectively on two sides of the intersection point; and
c2) calculating the wavelength of said at least one wavelength component with reference to the magnitude ratio and the wavelengths assigned to the coordinates of said two adjacent ones of the sensing cells.
